(19) United States
(12) Patent Application Publication
(10) Pub. No.: US 2018/0283614 A1
(43) Pub. Date: Oct. 4, 2018

(54) METHOD FOR REFILLING BAR CODED GAS CYLINDERS WITHIN A FILL ENCLOSURE, INFORMATION RECORDER AND MICROPROCESSOR REFILLING CONTROLLER

(71) Applicant: Firehouse Systems, Inc., Amityville, NY (US)

(72) Inventor: Fred GANDOLFO, Massapequa, NY (US)

(73) Assignee: Firehouse Systems, Inc., Amityville, NY (US)

(21) Appl. No.: 15/938,365

(22) Filed: Mar. 28, 2018

Related U.S. Application Data
(60) Provisional application No. 62/479,502, filed on Mar. 31, 2017.

(51) Int. Cl. F17C 13/00; F17C 13/04; G07C 9/00

(52) U.S. Cl. CPC F17C 13/003; F17C 13/045; F17C 2250/032; F17C 2205/0338; F17C 2205/054; G07C 9/00111

(57) ABSTRACT

A gas cylinder refilling system has at least one bar code reader disposed inside the gas refilling chamber and a gas control line for connecting a gas cylinder to a gas source inside the gas refilling chamber, the gas control line having a valve. There is a microprocessor (MPC) connected to a data storage unit, to the bar code reader and to the valve, and being configured to analyze information from the bar code reader such that when the information read by the bar code reader matches stored data in the data storage unit, the microprocessor signals the valve to feed gas to the cylinder.

### CROSS-REFERENCE TO RELATED APPLICATIONS

This application claims priority under 35 USC 119(e) of U.S. Provisional Application No. 62/479,502, filed on Mar. 31, 2017, the disclosure of which is herein incorporated by reference.

### BACKGROUND OF THE INVENTION

The present invention relates to gas cylinder refilling accessories and, more particularly, to a 2-dimensional bar code system for the safe refilling of gas cylinders within a fill enclosure, a gas cylinder information recorder, personal identification authentication record keeping and a microprocessor refilling controller.

Currently, it has been found that only 3% of the refillers of gas cylinders that were polled understand what is required. Cylinders have been found to be refilled years beyond their expiration and hydrostatic retest dates. This is dangerous, as high pressure cylinders can explode and cause catastrophic loss to life and property.

One of the reasons for this is that most people cannot decode the DOT (Department of Transportation) requirements for each cylinder they fill. In a fire department, hospital, large dive shop or paintball house, there can be hundreds if not thousands of cylinders, all with different expiration dates and retesting dates. The nature of these in-house refillers is to use whatever labor is available to refill the cylinders, and therefore some refill operators may not be fully trained or aware of the dangers and requirements of refilling high pressure cylinders used for SCBA, SCUBA, Paintball, Oxygen, Nitrogen, propane and other gases not included here that may from time to time be refilled in a cylinder mounted in an enclosure designed to safely fill gas cylinders.

DOT requires that all filling data be maintained in an easy to access record where the date, time, operator, pressures, serial number and hydrostatic test dates are recorded for every cylinder refilled. There are no assurances that people will manually fill in the required data in a record book. Data can be added or changed at will in a book. Pages can be lost or damaged, handwriting can be illegible. Data is not always understood by the refiller, causing some cylinders to be filled that should not be filled based on hydrostatic testing requirements and end of life of various cylinders. This creates dangerous and detrimental situations where property and life can be jeopardized.

Existing systems using RFID technology, such as those shown in U.S. Pat. No. 9,310,024 to Plummer et al. are hard to employ in the many different variations of gas cylinder material and commercially available fill enclosures. For instance, a cylinder manufactured by one company may have an area not surrounded by metal to mount an RFID tag. But a similar cylinder manufactured by another company may not have this available area. RFID tags cannot be attached to the cylinder per requirements of NIOSH (National Institute for Occupational Safety and Health) and the DOT. So they must be attached to another area, typically the valve or valve rubber bumper. This position is not always suitable for mounting an RFID tag between various manufacturers' RFID tags are subject to damage as they sit on top of, or inside a rubber bumper. This bumper is designed to protect the cylinder valve from damage, and adding the RFID tag to an existing cylinder bumper can negate the protective feature of the bumper, while the RFID tag can be damaged when the bumper is flexed in brackets or though mishandling during use. In addition, there are no clear and authorized ways to affix an RFID to a cylinder made of carbon filled fiber that meets the requirements of NIOSH and DOT, which require that no customer installed labels or items be affixed to the cylinder (with the exception of hydrostatic test labels). Nothing exists in the field for automatically recording this data required by DOT and NFPA (National Fire Protection Association), that complies with current NIOSH and DOT mounting restrictions. Nothing exists in the field that will control the fill process for refilling SCBA, O₂ and SCUBA cylinders, while recording operator information, makes fill or no fill decisions based on total life of the cylinder, hydrostatic retesting dates and mismatched pressures or gases, updating cylinder data, recording time and date of cylinder refill, that counts cylinder refills and protects that data for a minimum of 15 years on an off-site cloud server for data protection.

As can be seen, there is a need for a system for tracking, recording and properly filling gas cylinders, that can be easily deployed among various manufacturers of gas cylinders and safety fill enclosures and still comply with NIOSH, OSHA and NFPA rules regarding attachment of foreign objects to a gas cylinder.

In addition to the need to actively control the refilling of gas cylinders, there is a need to simplify the refill process itself. Many air refilling stations employ a “cascade” refilling control system to transfer gas from one cylinder in storage to another for refilling. For example, there may be 3 or more “banks” of gas storage cylinders controlled manually by opening and closing hand valves, or automatically though a series of pneumatically and/or electrically operated gas valves. Manual systems require extensive training and diligence to operate. The refiller must look at a series of pressure gauges indicating individual storage bank pressures, choose the lowest pressure (or highest pressure above the refilling cylinders pressure) and open the storage valve that coincides with that pressure. The refiller needs to monitor the refilling cylinder pressure for equalization with the current storage bank. When these two pressures equalize, the operator must close the current bank and open the next highest storage bank to refill the cylinder. This is repeated until the cylinder being refilled has been satisfied with the gas pressure from stored air. In the event that stored air cannot meet the pressure required of the cylinder, the operator must operate the compressor fill valve to “top off” the cylinder pressure from the compressor. Once cylinder pressure is satisfied, the operator then must switch the compressor valve again to send compressed air back to the storage banks for future use. This is confusing for experienced operators, and a danger for infrequent and inexperienced refillers who can easily be confused by the multitude of valves and gauges required of these common systems. In automatic cascade controls, the operation is simplified though a series of pneumatic or electromechanically operated valves, but is subject to extensive failures and repairs due to the wearing of O-rings, diaphragms, fittings, tubing, springs and seals used in these devices.

### SUMMARY OF THE INVENTION

The present invention aims to solve these problems and provides a system for tracking, recording and controlling gas cylinder refilling operations for various types of gas cylinders using two-dimensional bar codes instead of RFID tags on the cylinders. These tags are read by bar code readers and are connected to a microprocessor that controls the function of the filling system. The system of the present invention can solve the confusing task of recording hydrostatic test data and determining if gas cylinders are suitable for refilling. In the system of the present invention, bar code tags are installed on gas cylinders and data on these tags are read by a bar code reader which transmits the cylinder data to a microprocessor controller for a go or no go order. Fill data and cylinder data are captured for accountability. The required data is written on a two-dimensional bar code label that can be read and deciphered by a microprocessor controller that also records all the required data and makes a fill/no fill decision based on the facts contained in the two-dimensional bar code label.

The present invention also controls proper filling of the cylinders. When refilling gas cylinders, the rise in pressure (re-compressing of gas) within the cylinder generates heat. This heat can be explained in Boyles Law—gas expands when heated, increasing its volume over an equal amount of lower temperature gas. In systems without proper flow metering, when the heated gas cools to ambient conditions, the volume decreases and shows a marked decrease in cylinder pressure. This is a minor issue for those buying gas who may feel short changed in their purchase, but is a big problem with divers and firefighters who need the maximum air volume to complete their necessary tasks. Some refilling operators make the unsafe decision to overfill the cylinders so that when they cool, the pressure drop will bring the pressure in the refilled cylinder to the desired pressure. This is dangerous and can cause a cylinder to stretch past its design or fail. Other operators must reinsert the cylinder in their refilling system, topping off the refilled cylinder to reach its desired final pressure. This is safer, but time consuming and seldom done in the field.

To limit the heating of gas as it is recompressed within the cylinder, current systems use mechanical metering valves in the fill line to “slow down” air flow and pressure rise to a specific time. The mechanical devices must be set and may work well when there are no variables. However, in compressed gas refilling there are many variables, one of which is the quantity of cylinders refilled at one time. It is typical for a compressed breathing air refill station to refill one to three or more SCBA cylinders at one time. This goes for all gas refilling plants filling any type of gas. Not considering ambient conditions, gas temperature before refilling, cold expanding gas vs. heated recompressed gas, wear on metering valves and other factors, a metering valve cannot differentiate between one, two, three or more cylinders being refilled. This means the mechanical metering valve was set for the maximum number of refills, or the minimum, but seldom the amount being filled at any one time, which renders this type of control a poor choice.

The present invention limits this heat of compression by slowing down the flow and pressure rise of gas within one or many cylinders using a pressure rise vs. time calculation. The microprocessor measures the pressure rise in the cylinder(s) every 2 seconds and calculates the fill rate.

If the microprocessor determines that the fill rate is above accepted norms and settings, as an example 1200 PSI per minute, it will shut the dome load fill valve for (x) seconds via a solenoid valve to delay the total refill time. When this time period passes, the refill valve reopens allowing gas to flow to the refiling cylinder. This process is continuously monitored and acted on by the computer to limit pressure rise in the refilling cylinder to a desired, restricted level. Interrupting the gas flow will lengthen the time to refill cylinders, allowing them to refill in a controlled fashion and to limit expansion and contraction of the gas while protecting the integrity of the cylinder from rapid expansion, heat and uncontrolled contraction which can damage the cylinders.

The present invention also automates the cascade system with few moving parts, no gauges or manual valves and is controlled precisely through the microprocessor. Due to the nature of air pressure equalizing between two or more connected vessels, it is natural for the storage bank cylinders to eventually “equalize” with the refilling cylinder. When the gas pressure in the refilling cylinder has not risen (X) pressure, over (X) time, (has equalized with the open storage bank) the computer signals the relay on the I/O Board to close Bank 1 and open Bank 2. Bank 2 now provides the gas to the refilling cylinder. When pressure measurements determine that the refilling cylinder pressure has not risen (X) pressure in (X) time, the microprocessor closes bank 2 and opens bank 3. This continues through each bank until the refilling cylinder pressure is satisfied. There are no limits to the number of storage banks the present system can utilize. In the case where storage pressure in the various banks are not enough to satisfy the pressure requirement of the cylinder being refilled, the computer will direct air though a “by-pass or priority valve” to top off the refilling cylinder pressure directly from the air compressor, when one exists. This simple design completely automates a cascade system and simplifies the mechanics required to build and operate a manual or automatic cascade system control. To utilize the cascade control in our current system requires the addition of one 12VDC solenoid valve and one dome load valve for each bank of storage air as used in our invention to control air flow to the refilling cylinder.

To remove the harmful and corrosive effects of oily water condensate generated in idle air compressor systems, and purifiers, specifically breathing air compressors, NFPA Recommends that customers who operate air compressors for breathing air manufacturing run those air compressors at least one hour weekly. Fire Departments across the USA and abroad operate high pressure air compressors to generate the air used in self contained breathing apparatuses, commonly known as SCBA, But seldom meet the 1 hour weekly recommendation needed to purge and burn off this corrosive condensate.

The present invention incorporates an auto run purge circuit, built into the MPC Software to accomplish this effort. When selected in the set up software, the auto run purge circuit will count the number of cylinders refilled in the preceding 7 days. If less than a preselected number of cylinders were refilled in the prior week, the auto run purge will purge the compressor at a time and date of the owners choosing. If the owner needs to use the machine while the purge feature is operating, the MPC software program will open the I/O relay to close the purifier mounted dome load valve.

### BRIEF DESCRIPTION OF THE DRAWINGS

The invention will be explained with reference to the drawings. It is to be understood that the drawings are for reference only and are not to be considered limiting of the invention. In the drawings, wherein similar reference numerals constitute similar elements:

FIG. 1 is a side view of a typical explosion proof fill enclosure according to the invention;

FIG. 1a is an enlarged view of the electronic enclosure of FIG. 1;

FIG. 2 is a side view of a two-tank fill station according to the invention;

FIG. 3 is a typical air flow diagram showing air flow control components;

FIG. 4 is a view of the compressor and air bank system for refilling the tanks;

FIG. 5 is a side view of a compressed gas cylinder according to the invention;

FIG. 6 is a front view of a typical bar code reader used in the invention;

FIG. 7 is a perspective view of a personal RFID tag, disposed as a key fob, for use with the invention;

FIGS. 8a-8c show various views of a cylinder mounted two-dimensional bar code tag adapted to be attached to each cylinder being refilled in the system of the present invention;

FIG. 9 is a block diagram of the connection of several microprocessor controllers of separate systems to a remote server; and

FIGS. 10A and 10B show block diagrams of the method steps according to the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

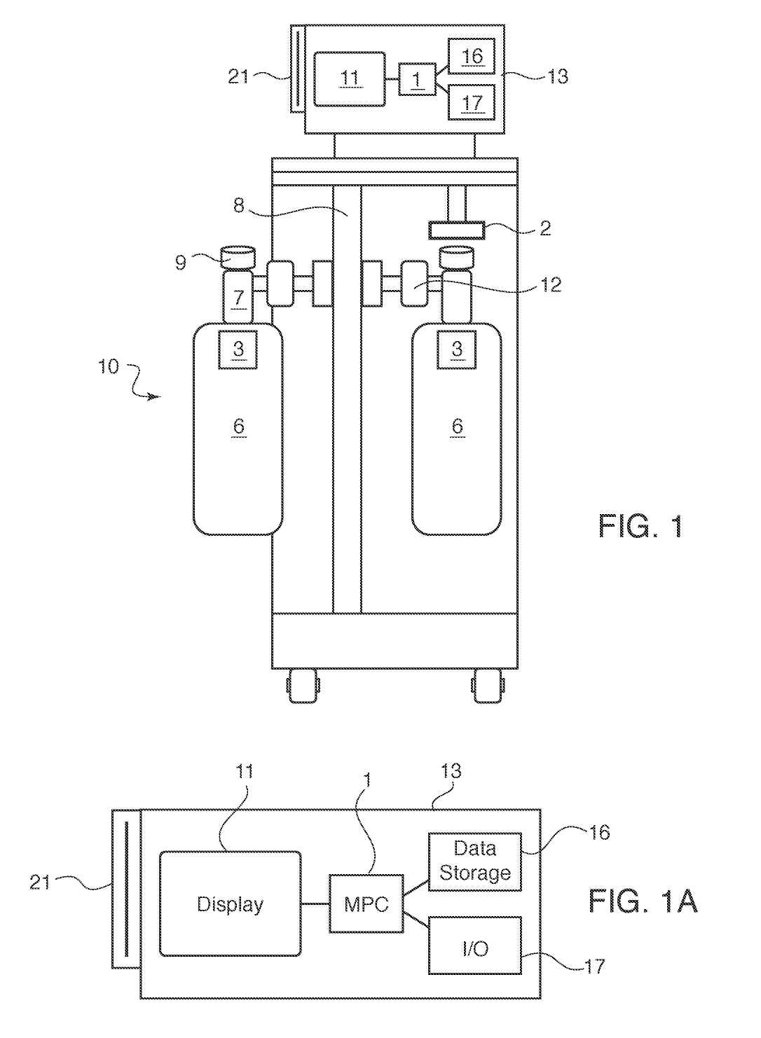

Referring now to FIG. 1, there is shown a side view of a typical explosion proof fill enclosure 10. These fill enclosures 10 are designed to contain rapidly expanding gas and debris in the case of a catastrophic cylinder failure during the refill process. The invention can be used in any style or brand of fill enclosure or with no enclosure at all.

In this drawing, the sides of the refilling enclosure are not shown for clarity. On this type of fill enclosure 10, the gas cylinders 6 are connected directly to the fill fittings 7 via cylinder valve 9 mounted on the revolving door 8. Other fill enclosures mount the cylinders differently, some in a tilting carriage or drop style door with filling connections made with hose and fittings.

A microprocessor-controller (MPC) 1 containing cylinder accountability software is mounted on enclosure 10 and is connected to bar code reader(s) 2 mounted inside the enclosure 10 as well as to a data storage unit 16 and I/O board 17. A bar code label 3 is attached anywhere to the cylinder, where the bar code reader 2 can read from its mounting position.

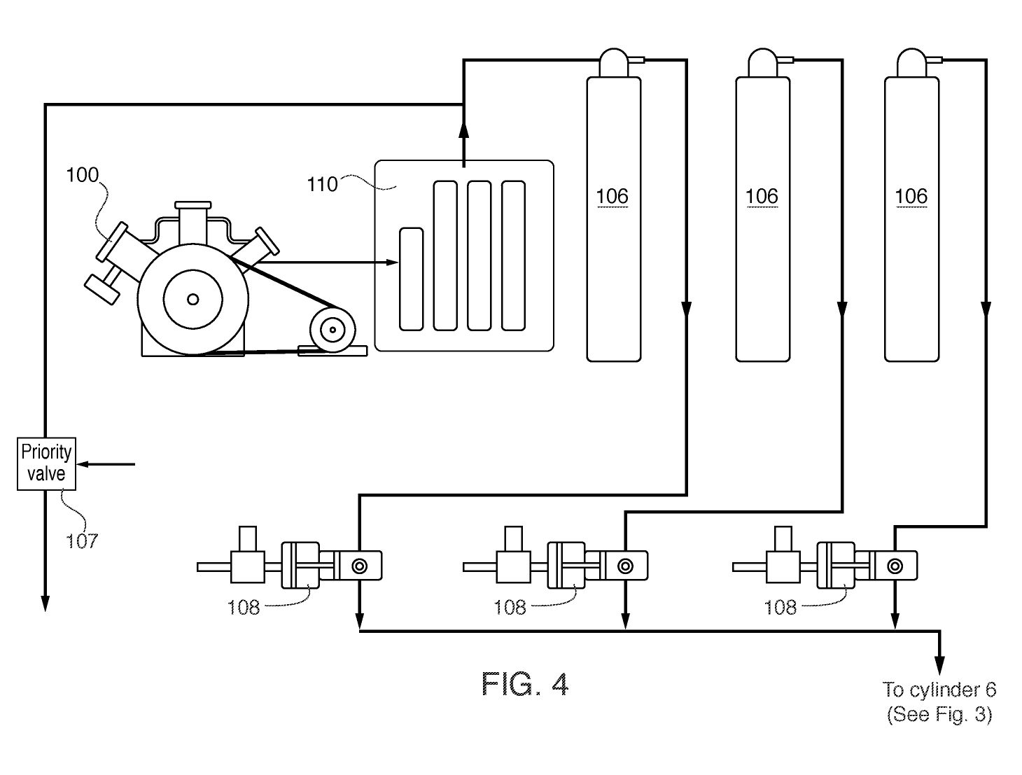

The MPC 1 is a commercially available industrial computer that will run the software program for the invention. The MPC will accept electrical inputs from the bar code reader(s) 2, bar code tag 3, personal RFID key fob 50 (see FIG. 7) and pressure transducer 43 (see FIG. 3). The MPC 1 will operate a solenoid valve 35 (see FIG. 3) to control gas flow per the instructions contained in the developed software for the invention.

When the cylinders 6 are rotated into the fill enclosure 10, they are suspended directly below the Bar Code Readers 2 located inside the enclosure 10. This drawing is for clarity only, the invention is not limited to one style of fill enclosure, but will work will all existing and new safe style fill enclosures on the market.

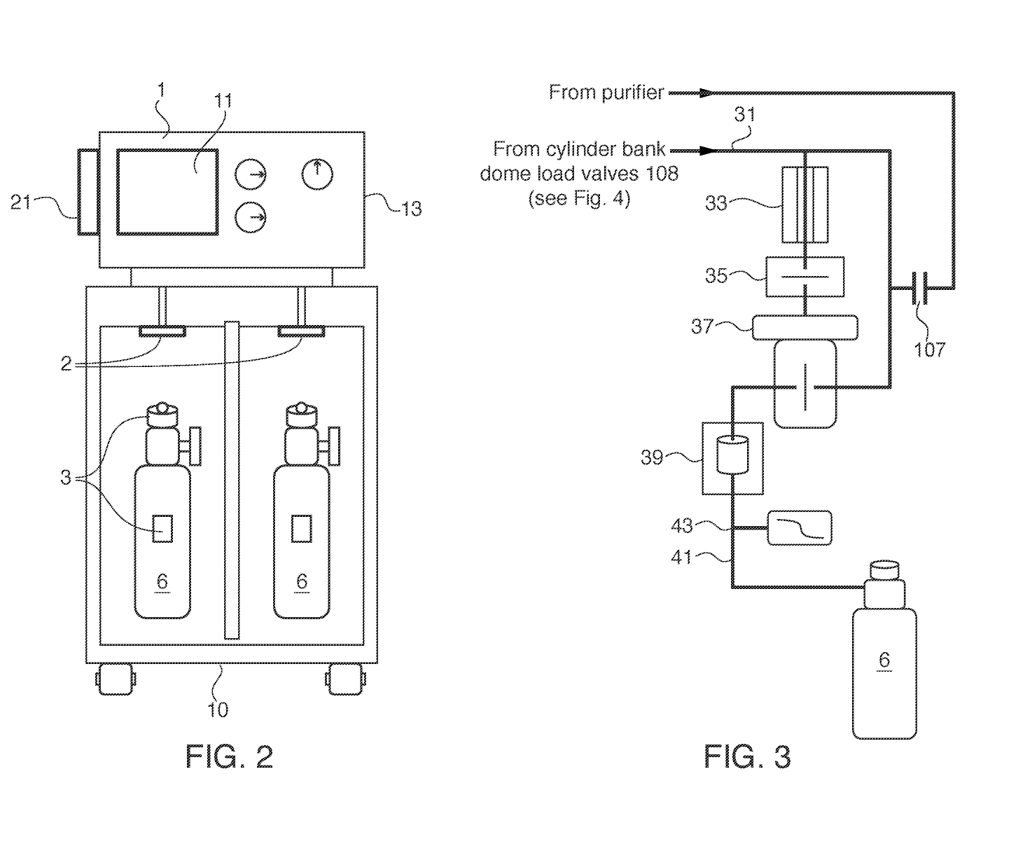

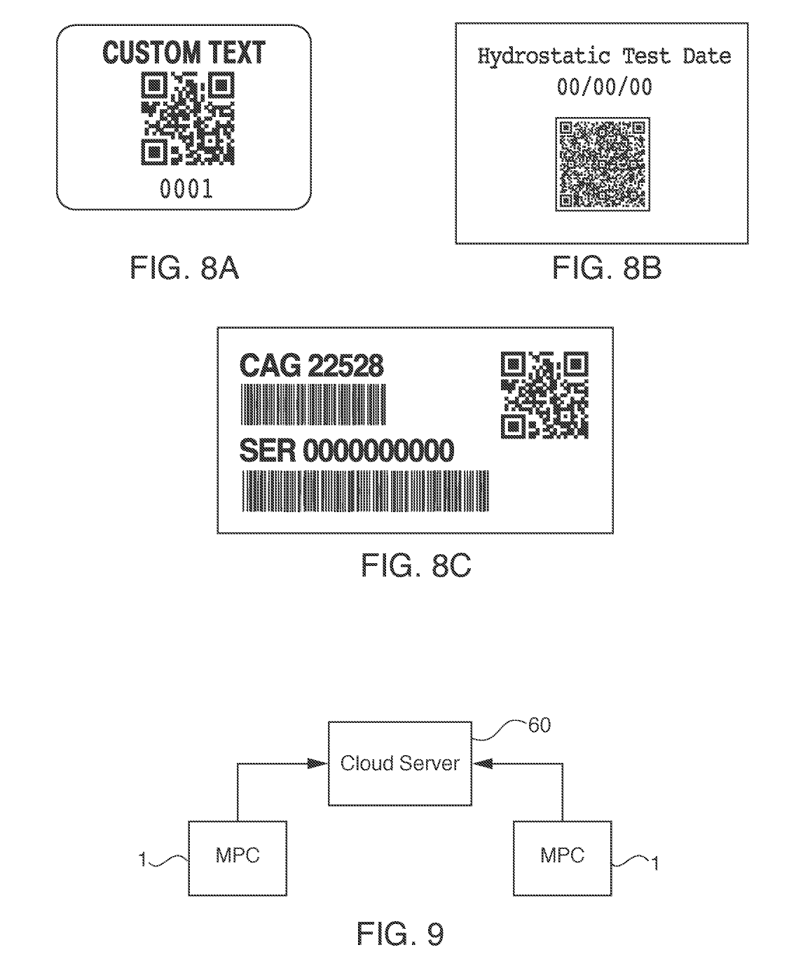

Bar code reader(s) 2 can be mounted anywhere within the fill enclosure 10, including top, bottom, all sides and outside when viewed through a window. Bar code labels 3 can be attached to gas cylinders 6 and can be programmed with the necessary cylinder data, as shown in FIGS. 8a-8c. Bar Code readers 2 can be disposed to read the bar code labels 3 and transmit that data to the MPC 1 (FIGS. 1 and 2). The MPC 1 can digest data sent from the readers 2 as quelled from the bar code labels 3 to operate the system per the program instructions. The MPC 1 writes the necessary record data, operator information, pressure to a data file in data storage unit 16 for broadcast to a personal computer, network device or over the internet to a cloud server for safe maintaining of fill records and cylinder data.

FIG. 2 shows an explosion proof cylinder refilling enclosure with two fill positions for two canisters 6. The door and fittings have been omitted from the drawing for clarity. This type of fill enclosure was chosen for clarity of drawings, any current or new design will be used for this invention. The invention includes the MPC 1.

MPC 1 has a receptacle 21 for authorizing personal RFID Tags 25 (see FIG. 7) (or a fingerprint reader (not shown)) that are programmed with the operator's personal data and authorization to use the system. This personal RFID tag 25 can be used to start the process. It is shown on this drawing on the front of a fill enclosure, air management control panel, but can be located anywhere it is convenient for the operator of the fill enclosure, including wall or pedestal mounted. To maintain accountability and restrict the refilling process to only those refilling operators who are authorized and trained to use the equipment, this invention utilizes personal identification to access the system to refill gas cylinders.

The purpose of RFID tag 25 is to limit access to those authorized by the owner of the equipment and to those trained in its use and for record keeping and accountability. Personal RFID tag 25 is preprogrammed with a unique ID number assigned during manufacture. The ID number is written into the user program to identify the authorized user. A fingerprint scanner (not shown) could be used as an alternative or in addition. Alternatively, the system could require the user to type in a unique personal identifier and password onto the touch screen to gain access to the system. For example, the users wave a personal RFID tag 25 in the form of a key fob in front of reader 21. The reader 21 picks up the unique identification number, and sends it the MPC 1 to grant access to the system.

The invention could also include an electronics enclosure 13. The enclosure houses the electronic I/O boards 17 that communicate with the MPC 1 the bar code readers 2 as well as the personal RFID reader 50 or finger print reader (not shown) used to access the system and for accountability.

The invention includes up to sixteen (16) commercially available bar code readers 2. The bar code reader(s) 2 are installed on or in the enclosure 10 in a position enabling them to read the data installed on the cylinder mounted bar code labels 3.

A touch screen 11 connected to MPC 1 allows filling functions to be monitored and changed with authorization.

The cylinder bar code labels 3 are read from the bar code readers 2 and information is relayed electrically to the MPC 1. A sample bar code reader 2 is shown in FIG. 6. The MPC 1 digests the information contained on the bar code labels 3 and makes a decision to fill or reject the cylinders 6 in the fill enclosure 10. The MPC 1 checks the data from the labels 3 for a current hydrostatic test date and that the cylinders are within a specified time from their manufactured date to determine if the cylinders should be filled or rejected. The MPC 1 can also check that the operator is authorized by the owner to operate this machine as well as the cylinders are authorized to be filled. The MPC 1 records the important cylinder information, refiller information, date, fill pressure and time to fill in a database for retrieval wirelessly or, by wire to a PC or over the internet and for safe storage in a third-party cloud server. These records can be maintained by the owner for proof of inspection, compliance with DOT requirements, compliance with NFPA (national fire protection agency) requirements and are kept on file for accountability purposes for a minimum of the life of the cylinder, typically 15 years. Other recorded information includes the amount of fills a particular cylinder has received so it is not filled above the maximum times allowed in some cases, these fill episodes are contained in the MPC memory for rejection if necessary.

As an option, the collected data can be used for billing purposes or for determination of the need for compressor service when number of cylinders are filled in a given period.

FIG. 3 is an air flow diagram showing the operation of the system during filling of a cylinder 6. In the diagram, gas at high pressure (6000-7000 psi) enters a pipe 31 at the gas inlet, flowing to a fixed pressure reducer 33 where system gas pressure is reduced to 120 PSI. The gas at reduced pressure stops at solenoid valve 35 and is held there until the I/O Board signals the solenoid valve 35 to open by sending an output of 12V DC to the solenoid valve 35. When solenoid valve 35 is signaled to open, gas flows to dome load valve 37, which opens via a piston. The gas flows from dome load valve 37 under full system pressure to flow restrictor 39, which restricts the gas flow to the cylinder 6 to a maximum increase of 1500 psi/minute. The restricted gas flows out piping 41 to cylinder(s) 6. Restricting air flow is necessary to limit the temperature rise inside refilling cylinders 6. Cylinders that are filled too rapidly can overheat and stretch, causing premature cylinder failure. By restricting pressure rise in the cylinder 6 to a rate of 1200 to 1500 PSI per minute heat generated inside the cylinder is limited.

Pressure transducer 43 converts PSI to an electrical signal and sends to I/O board 17 where the electrical signal is converted to a digital signal to be read and acted on by the MPC 1 (See FIGS. 1 and 2). Pressure reducer 43 reduces system pressure to a workable pressure for the solenoid valve 35 and dome load valve 37. Pressure reducer 43 reduces 5000-7000 PSI system pressure to 100-120 psi. A solenoid valve 35 accepts a signal from the microprocessor 1 to send air pressure to the dome load valve 37. The dome load valve 37 opens when signaled from the solenoid valve 35 and when 120 to 150 psi is sensed on the valve's internal piston dome, and allows gas to flow to the cylinders 6. A keyed electric switch connected to priority valve 107 allows emergency operation of the system if there is a failure within the system. The pressure transducer 43 is also used to stop the fill process when the MPC 1 receives the expected electrical pressure set points as indicated on the bar code label 3 for that cylinder and converts to a pressure setpoint.

FIG. 4 shows a typical cascade filling system to be used with the invention. In this arrangement, a gas compressor 100 sends compressed gas on demand to a gas purifier 110. Gas purifier 110 cleans the gas of impurities and sends clean compressed gas to storage bank(s) cylinder(s) 106. On a manual fill command from the MPC 1, the system gas control valve and storage bank dome valves 108 open, allowing gas to flow through the valves depicted in FIG. 3 to a refilling cylinder 6 in a typical fill enclosure 10 as shown in FIGS. 1 and 2. Gas pressure in the refilling cylinder 6 is measured by the MPC 1 via the transducer 43 (FIG. 3) every two seconds, as a part of the inventions normal software control. For digital auto cascade operation, this gas pressure measurement in refilling cylinder(s) 6 is measured for pressure rise over time. When the MPC 1 determines the refilling cylinder 6 has had no appreciable pressure rise in X-Time, the MPC 1 will send a command to the I/O Board 17 to close the bank dome load valve 108 connected to the bank cylinder 106 that was used for refilling, and open the next bank dome load valve 108 in sequence. This measurement of pressure rise and the control of dome load vales 108 will continue in sequence until the refilling gas cylinders 6 in enclosure 10 have been satisfied with their programmed pressure. When the refilling cylinders 6 have met their designated pressure, the MPC1 sends a command to the I/O Board 17 to close the inventions system gas control valve (FIG. 3) and the last open 108. In the event the compressor systems available air storage banks cannot satisfy the refilling cylinder's 6 programmed pressure, The invention's system gas control valve will stay open to allow the auto by-pass refill priority valve 107 in the compressor piping circuit to top off the refilling cylinders 6 to their designated pressure.

The invention is designed to be retro-fit to most commercial refill stations already owned for those who cannot purchase new refill systems but desire a compressed gas cylinder accountability system. As an example, a city fire agency may have 2 or more compressed gas (breathing air compressor) refilling stations located in various fire stations around the city. Most city fire agencies desire a cylinder accountability system that will control and record the refilling process, maintain inventory, keep inexperienced refill operators safe and keep their department in compliance with the federal and state agencies. The problem most city agencies face is they cannot afford to replace all of their refill stations to add this accountability feature.

The system can include a compressor run circuit that will exercise the customer's air compressor as required by NFPA for a period of one hour weekly, provided the customer did not already operate their breathing air compressor for one hour in the preceding week. The bar code refill system counts cylinders filled during the preceding week, if less than a predetermined quantity were filled, a run and drain command are sent to the compressor 100's controller to exercise the compressor 100 for one hour. This circuit is optional and can be turned on or turned off through the touch screen 11 as required by that particular compressor 100.

In operation, the MPC 1 counts the preceding week's cylinder refills recorded in the software. If this is less than a preselected amount, the MPC 1 will send a command to the I/O Board 17 to close a relay associated with Auto Run Purge. This closed relay will send an electrical signal to an additional solenoid valve installed at the discharge of the purifier 101 (not shown). This purging gas will drain through a muffler and flow reducer to waste. As this air drains, the compressor run circuit will pick up the pressure drop in the system and start the compressor 100. The MPC 1 will keep this relay closed for one hour, allowing the compressor to run long enough to heat up and purge the compressor and purifier of condensate, without filling the bank cylinders 106.

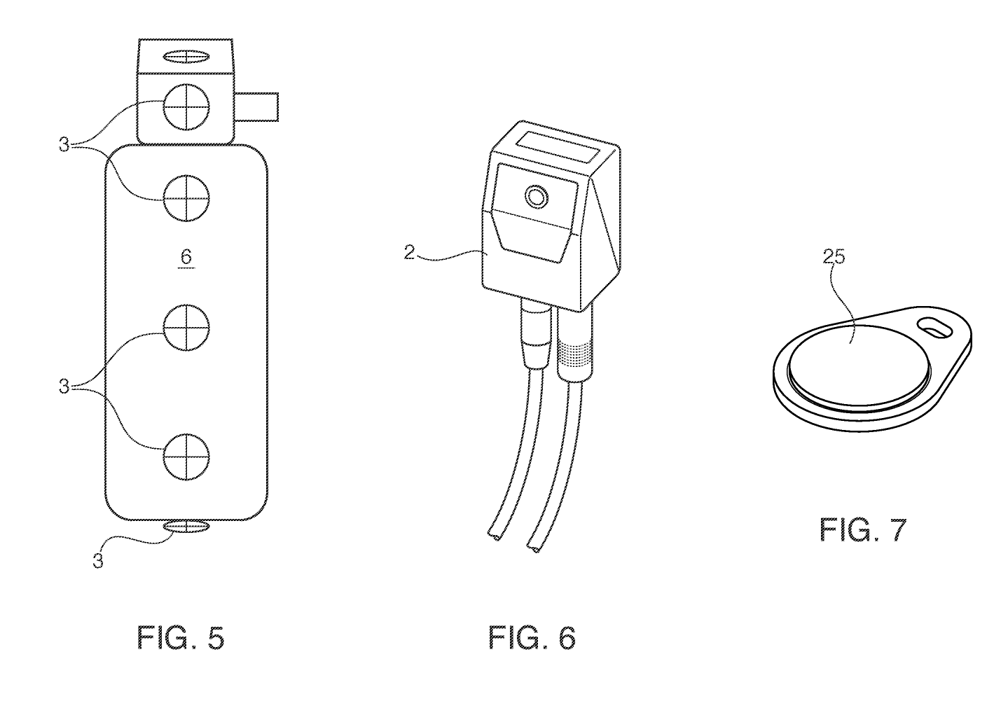

FIG. 5 shows a cylinder 6 with different locations for bar code tag 3. This drawing shows possible bar code label placement positions. For example, the bar code label 3 could be placed inside the cylinder valve bumper indent, on the cylinder valve, on the cylinder body in the upper, center or lower portions, or on the bottom of the cylinder body.

The only restriction is that the label 3 be placed in a position on cylinder 6 that will not interfere with normal cylinder operation and can be read by the bar code reader 2 located within the fill enclosure, mounted on wall or pedestal near refilling operations.

The position of the bar code label will be determined by the enclosures available mounting position(s) for the bar code readers 2. Mounting positions could vary depending on brand and operational style of fill enclosure 10. Bar code reader(s) 2 can be mounted inside, or outside fill enclosure 10 as required to consistently and accurately read cylinder mounted bar code label 3.

FIG. 8 shows sample bar code labels 3 according to the invention. Cylinder affixed labels having bar codes or QR codes will also have a human readable Hydrostatic date to meet the requirements of DOT. The labels can be in any form that is readable by bar code readers 2 and which contain the necessary information for MPC to decide whether filling the cylinders 6 is allowed.

The present invention is designed to safely refill SCBA, SCUBA, O₂ and other gas cylinders as a stand-alone controller to an existing design fill station or a newly manufactured fill enclosure when the manufacture or owner of the fill station desires a bar code reading system to control or to augment their existing designs. It could be enhanced by adding a high pressure air control program used to control the function of a breathing air compressor that supplies breathing air to the fill station. Additional redundant safeties can be added. Additional information can be written to the data file.

The system of the present invention can control all aspects of a complete refill system, including the compressor, CO and H₂O monitors, O₂ generator controls, motor start/stop control, failure annunciation and shutdown and other control aspects of a new or existing compressor/gas generator system.

The system of the present invention can check for mis-matched cylinders for both pressure and gas that are connected to a refilling system at the same time. For example, in the self-contained breathing apparatus (SCBA) industry (fire department use, for example), there are found different pressure ratings of cylinders typically found in fire houses. They are not marked clearly and untrained refillers may not be aware that different pressure cylinders are connected to the filling system at the same time. This could result in lower pressure cylinders (such as 2216 or 3000 psi cylinders) being filled at higher pressure levels (4500 or 5500 psi), which can blow the pressure shear disc in the lower pressure cylinder valve. This would cause cylinder degradation or immediate failure of the cylinder which could cause loss to life and property.

The system of the present invention can check and differentiate mismatched gas. An untrained or unauthorized operator may attempt to fill a medical oxygen cylinder with another gas. This is quite common when owners of cylinders wish to use them for other than their intended purpose.

In the present invention, the MPC, when prompted by the operator, initiates an internal fill program. The filling program instructs the MPC to read the bar code labels attached to each cylinder. This information is returned to the MPC where the information from the bar code label is populated into the system controller and compared to the data on record for that specific cylinder by serial number.

When the MPC 1 has retrieved the cylinder data, it is compared to the “norms” associated with refilling that particular cylinder. The MPC 1 looks at the cylinder data and makes a refill decision based on, cylinder rated pressures within the filling enclosure at one time, (safe fill, fill enclosures require only one cylinder pressure rating be refilled per evolution) manufactures date of the cylinder and expected last hydrostatic test date. When data presented to the MPC as quelled from the Bar Code Label meets the expected information for that cylinder, and the cylinder is confirmed to be within its maximum life, within required hydro test dates and is the same pressure as the other cylinders within the fill enclosure, a fill command is issued by the MPC to the control board that operates the solenoid and dome valves to refill the cylinder. Existing mechanical systems cannot compare cylinder pressures within the fill station which could cause overfilling or under filling of cylinders.

For example, the MPC 1 compares pressure ratings of each cylinder 6 within the enclosure 10. If they do not match, a warning is displayed. “all cylinders must be of the same pressure”. The MPC also compares the manufacturer's date of the cylinder. If the cylinder is beyond its maximum operational life, a warning is displayed. “Cylinder in Position X is past its maximum life and cannot be filled”. The MPC 1 also compares the last hydrostatic test. If the cylinders 6 are past their particular Hydrostatic test date, the MPC displays “Cylinder in Position X is past Hydro and cannot be filled.” The MPC 1 compares the number of refills for each cylinder, and if the number exceeds the maximum number as defined by the manufacture or various governmental agencies, the MPC 1 will display “cylinder in position has exceeded its maximum refills and cannot be refilled”.

When all presented cylinders 6 are found in the data base and are within their maximum fill life, have not exceeded their maximum fill cycles, are within the prescribed hydrostatic test dates and are all the same pressure, the MPC 1 will send a digital control signal to the conversion board which will send an electrical signal to the solenoid valve 35 located on the gas control piping.

The MPC will continuously read the cylinder gas pressure digital signal from the pressure transducer to monitor pressure within the cylinders being refilled. Once the rated cylinder pressure is achieved, the MPC will send a signal to the gas control valve to stop and the cylinders will stop filling. At this point, the cylinder records will be updated in the MPC data base with the time and date of the refill as well as the name of the operator as recorded during sign in. All refilling data will be captured in memory on the MPC hard drive and an external drive. The system also includes the use of an off-site 3^{rd} party cloud storage facility. This allows multiple refill systems to communicate with one another. In the case of an owner who employs multiple fill enclosures over a wide area, such as a Fire Department, the data for all refilling systems can be uploaded and joined within a cloud server 60, as shown in FIG. 9. This is accomplished in two ways, manually by touching a key on the display 11, or automatically when the cylinder refill system is idle for more than 3 hours. In automatic mode, the MPC 1 initiates a data transfer to the cloud server 60. The cloud server 60 maintains all refilling and operator data for safe offsite storage in case of an MPC Failure.

Refilling data can be easily transferred to a replacement computer when installed. For example, this data can be emailed to the owner to hand to OSHA when they demand these records be produced. The purpose of maintaining the data in three distinct areas is to protect it in case of failure or theft of equipment. By maintaining records on a cloud-based server 60, the system data will be maintained in case of a local calamity. Operators, cylinder inventory, Cylinder refilling operations, next hydrostatic test dates by cylinder, expiration by cylinder. When connected to an internet provider, the system has the capacity to automatically send selected reports by email to the owner on a monthly basis.

As the cylinder 6 is being refilled, the MPC 1 monitors the converted electrical signal from the pressure transducer 43, and when the pressure rating of the cylinder 6 is met as read from the bar code label 3, the MPC 1 sends a control to the valve 35 to stop the refilling process. At this point the MPC 1 updates the cylinder refilling data in its internal memory and writes this data to the external SIM card as additional back up.

The MPC 1 for each system can be connected to the internet by wire (CAD5) by Blue Tooth, or by WIFI this enables the owner and manufacturer to remotely log into the system to receive reports on: cylinder inventory, fill evolutions, and operator data. Reports are generated by the microprocessor 1 and can be sent to any email address in PDF and EXCEL format so that it can be filed or shared by others.

The wireless and direct wire abilities allows the bar code refilling system according to the invention to communicate with the off-site cloud server 60 for data backup and synchronization of data, as well as access by the manufacturer to troubleshoot and program the system. Additional updates to the system can be downloaded remotely by the manufacturer as these programs are modified and updated for a particular system or added purpose.

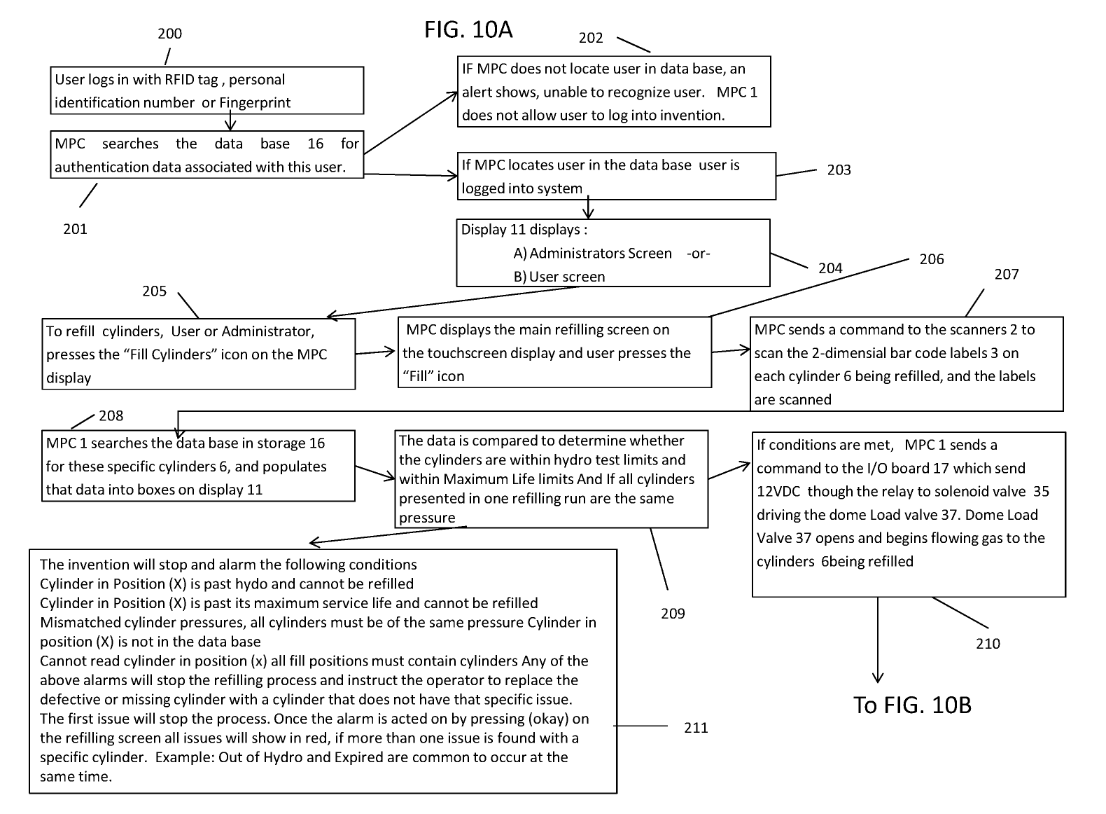

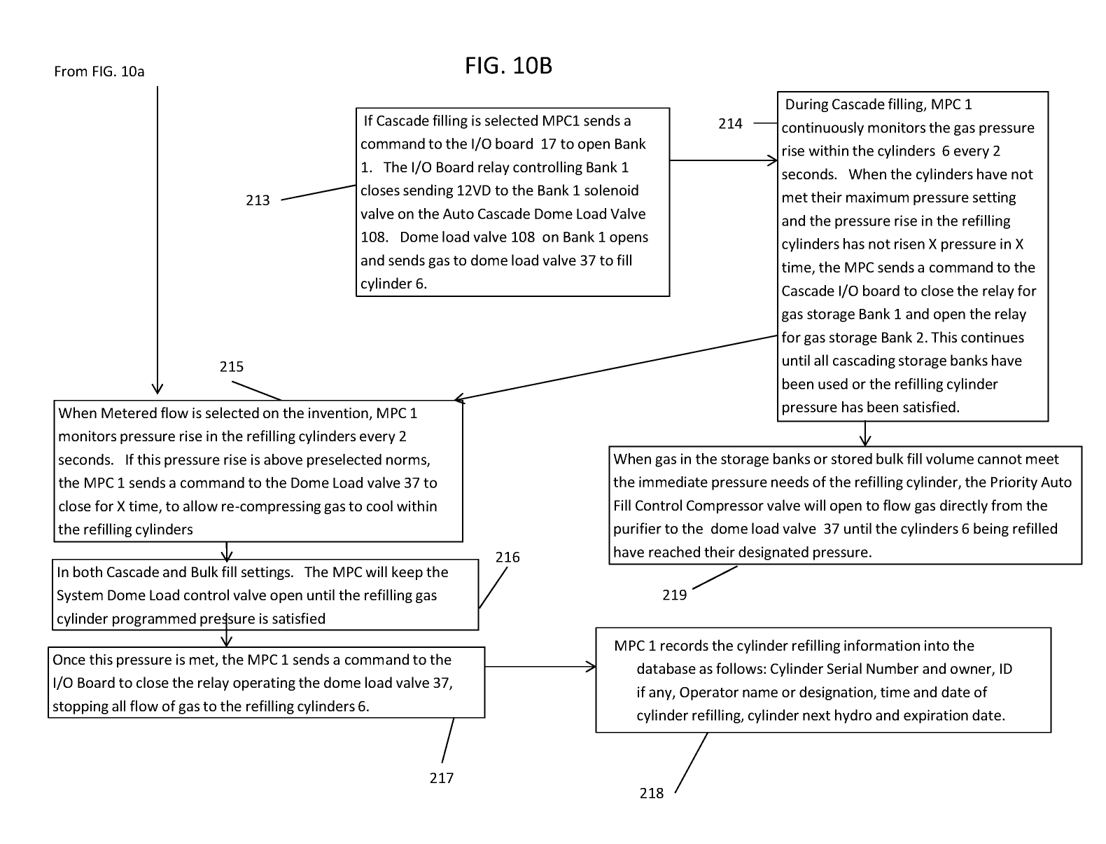

FIGS. 10a and 10B shows the sequential method steps for performing a filling operation according to the invention. In step 200, the user logs in with the RFID tag 25, personal identification number or fingerprint, and in step 201, the MPC 1 searches the database connected to the data storage unit 16 for authentication data associated with this user. In step 202, if the IF MPC does not locate the user in the data base, an alert indicates that the user is not recognized. MPC 1 does not allow user to log into invention and the operation is terminated.

In step 203, if the MPC locates the user in the database, the user is logged into the system. The display 11 then displays an administrator screen or a user screen in step 204.

To refill cylinders 6, the user then presses an icon on display 11 indicating cylinder filling, in step 205. In step 206, the user initiates filling the cylinders by pressing a fill icon on the screen. In step 207, the MPC 1 sends a command to bar code scanners 2 to scan the bar code labels 3 on the cylinders in the enclosure. Data from the scanned labels is sent to the MPC in step 208, which searches for the specific cylinders in the database and populates the data in boxes on display 11. In step 209, this data is compared to stored data about these cylinders to determine whether the cylinders should be filled. If that data indicates that the cylinders are past hydro or maximum service life, the cylinder is not in the database, the cylinders cannot be filled at the same pressure, or there is a missing cylinder in a fill position, the system will stop and an alarm signal will be given in step 211.

If the conditions are met, then in step 210 MPC 1 sends a command to I/O board 17 to open a relay associated with solenoid valve 35 and dome load valve 37 and start the filling process, in a bulk filling system, when all cylinders are filled from one volume of gas. If instead a cascade filling process is used, in step 213, MPC 1 sends a command to the I/O board 17 to open Bank 1. The I/O Board relay controlling Bank 1 closes, sending 12VD to the Bank 1 solenoid valve on the Auto Cascade Dome Load Valve 108. Dome load valve 108 on Bank 1 opens and sends gas to dome load valve 37 to fill cylinder 6. In step 214, during Cascade filling, MPC 1 continuously monitors the gas pressure rise within the cylinders 6 every 2 seconds. When the cylinders have not met their maximum pressure setting and the pressure rise in the refilling cylinders has not risen X pressure in X time, the MPC sends a command to the Cascade I/O board to close the relay for gas storage Bank 1 and open the relay for gas storage Bank 2. This continues until all cascading storage banks have been used or the refilling cylinder pressure has been satisfied.

In step 215, with either cascade or bulk filling, when metered flow is selected, MPC 1 monitors pressure rise in the refilling cylinders every 2 seconds. If this pressure rise is above preselected norms, the MPC 1 sends a command to the Dome Load valve 37 to close for X time, to allow recompressing gas to cool within the refilling cylinders. In step 216, MPC 1 will keep the dome load control valve 37 open until the refilling gas cylinder programmed pressure is satisfied. In step 217, once this pressure is met, MPC 1 sends a command to the I/O board 17 to close the relay operating the dome load valve 37, stopping all flow of gas to the refilling cylinders 6. At this point, in step 218, MPC 1 records the cylinder refilling information into the database as follows: cylinder serial number and owner ID if any, Operator name or designation, time and date of cylinder refilling, cylinder next hydro and expiration date.

During filling, in step 219, when gas in the storage banks or stored bulk fill volume cannot meet the immediate pressure needs of the refilling cylinder, the Priority Auto Fill Control Compressor valve 107 will open to flow gas directly from the purifier to the dome load valve 37 until the cylinders 6 being refilled have reached their designated pressure.

It should be understood, of course, that the foregoing relates to exemplary embodiments of the invention and that modifications may be made without departing from the spirit and scope of the invention as set forth in the following claims.

What is claimed is:

1. A gas cylinder refilling system comprising:
at least one bar code reader;
a gas control line for connecting a gas cylinder to a gas source inside the gas refilling chamber, the gas control line having a control valve; and
a microprocessor (MPC) connected to a data storage unit, to the bar code reader and to the valve, and being configured to analyze information from the bar code reader such that when the information read by the bar code reader matches stored data in the data storage unit, the microprocessor signals the valve to feed gas to the cylinder.

2. The gas cylinder refilling system, further comprising at least one gas cylinder and being connected to the gas control line, the gas cylinder having a bar code label disposed therein, wherein the bar code label is readable by the bar code reader.

3. The system according to claim 2, wherein the bar code label is a two-dimensional bar code label.

4. The system according to claim 3, wherein the bar code label is coded to contain the following information:
manufacturer of cylinder, cylinder Serial Number, date of manufacture, last hydrostatic test date, pressure rating, maximum refills and owner's name.

5. The system according to claim 1, wherein the gas control line has a pressure transducer configured to convert a gas pressure in the line to an electrical signal that can be read by the MPC.

6. The system according to claim 5, further comprising a limiting valve in the gas control line for lowering a pressure of gas in the gas line prior to filling the cylinder.

7. The system according to claim 1, further comprising a security system configured to allow filling of the cylinders only upon authentication of an authorized user.

8. The system according to claim 7, wherein the security system comprises an RFID reader connected to the MPC, and an RFID tag for each authorized user, such that when the RFID reader reads a RFID tag from one of the authorized users, the MPC is engaged to receive data from the bar code reader.

9. The system according to claim 1, further comprising a display connected to the MPC.

10. The system according to claim 2, wherein there are at least two bar code readers and at least two cylinders.

11. The system according to claim 5, wherein the MPC is configured to signal the control valve to reduce the flow of gas through the gas control line to the cylinder when the MPC receives data from the transducer indicating that a predetermined pressure in the gas line has been exceeded.

12. The system according to claim 1, further comprising a remote computer and wireless connection between the remote computer and the MPC, such that data from the MPC is sent to the remote computer for storage.

13. A method for filling a gas cylinder comprising:
affixing a bar code label on the gas cylinder, the bar code label being coded to contain identifying information about the gas cylinder;
connecting the gas cylinder to a gas control line, the gas control line having a control valve and being configured for feeding gas to the cylinder,
reading the identifying information from the bar code label with a bar code reader;
comparing with a microprocessor the information read by the bar code reader with stored data, and
if the read information matches the stored data, opening the valve with the microprocessor to allow gas to flow into the cylinder.

14. The method according to claim 13, wherein the information read by the bar code reader includes the serial number of the cylinder, expiration date of the cylinder, hydrostatic test due date, the time and date of the last refill of each cylinder and the name of the last person who refilled each cylinder.

15. The method according to claim 13, further comprising measuring gas pressure in the gas control line and regulating the pressure by closing the control valve with the microprocessor when the pressure in the gas line exceeds a predetermined pressure.

16. The method according to claim 15, further comprising the step of re-opening the control valve when the pressure drops below the predetermined pressure.

17. The method according to claim 13, further comprising storing all data read by the bar code reader in a database connected to the microprocessor.

18. The method according to claim 13, further comprising the step of authenticating a user by reading a RFID tag of the user with a RFID reader connected to the microprocessor, and activating the microprocessor when data read by the RFID reader matches stored data.

19. The method according to claim 16, further comprising sending the stored data to a remote computer.

20. The method according to claim 13, further comprising measuring with the microprocessor a number of cylinders filled over a period of time and, if the number of cylinders filled is less than a predetermined number, operating an air compressor in the chamber for a set period of time.
